(19) United States
(12) Patent Application Publication
(10) Pub. No.: US 2010/0119170 A1
(43) Pub. Date: May 13, 2010

(54) IMAGE COMPRESSION BY COMPARISON TO LARGE DATABASE

(75) Inventors: Srinivasan H. Sengamedu, Bangalore (IN); Malcolm Slaney, Sunnyvale, CA (US)

Correspondence Address: MARTINE PENILLA & GENCARELLA, LLP, 710 LAKEWAY DRIVE, SUITE 200, SUNNYVALE, CA, 94085, US

(73) Assignee: YAHOO! INC., Sunnyvale, CA (US)

(21) Appl. No.: 12/266,922

(22) Filed: Nov. 7, 2008

(51) Int. Cl. G06K 9/00

(52) U.S. Cl. 382/251

(57) ABSTRACT

A method of reducing storage capacity needed to store a target image in a large database of images is presented. A target image is uploaded from a client system to a server system, which are connected through an Internet connection. An image index is queried to find an approximate match to the target image and to identify a most similar reference image to a processed target image stored in an image database. The difference between the target image and a raw image corresponding to the identified most similar reference image is encoded. A pointers corresponding to the processed reference image stored in the image index is updated to reflect the newly stored target image in the image index.

### BACKGROUND OF THE INVENTION

An inordinate amount of resources is spent storing the large number of user images that are uploaded to various Internet websites for storage, sharing with others, or as email attachments. Additionally, several copies of similar images may be stored in the image database and each copy of each image is stored in its entirety. Also, the number of images and image resolutions are constantly increasing with the proliferation of inexpensive, high resolution digital cameras. All of these factors contribute to the ever increasing storage resources required to store these images.

While websites providing online storage of images can continue to increase the amount of storage used to store images, other issues associated with increasing the amount of physical storage capacity increases as well. The physical space required to house the physical storage, the complexity of managing the images, and the amount of power consumed by the increasing number of storage arrays will also increase. Rather than continue to increase storage capacity it would be desirable to slow down the increase in storage by developing a more efficient method of storing images.

It is in this context that embodiments of the invention arise.

### SUMMARY OF THE INVENTION

Broadly speaking, the present invention fills these needs by providing a method and apparatus for storing a target image based on comparison to an image database. The present invention provides a robust method that trades off processing resources for storage resources to address the increasing storage requirements for storing images online. It should be appreciated that the present invention can be implemented in numerous ways, including as a method, a system, or a device. Several inventive embodiments of the present invention are described below.

In accordance with one aspect of the invention, a method of reducing storage capacity needed to store a target image in a large database of images is detailed. A target image is uploaded from a client system to a server system, which are connected through an Internet connection. An image index is queried to find approximate matches to the target image and to identify a most similar reference image stored in an image database. Searching a large image index is efficiently performed using sub-linear algorithms. The difference between the target image and a raw image corresponding to the identified most similar reference image is encoded. A pointer corresponding to the reference images stored in the image index is updated to reflect the newly stored target image in the image index.

In accordance with another aspect of the invention, a system enabling storage of a target image based on comparison to an image database is provided. A client system uploads a target image to a server system through an Internet connection. The server system preprocesses the target image to generate a processed target image and performs a search to find a most similar reference image to a processed target image using a sub-linear algorithm. The difference between the target image and a raw image corresponding to the identified most similar reference image is calculated by the system server and stored in the image database. The server system reconstructs the target image upon a download request from the client system.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 illustrates system enabling storage of a target image based on comparison to an image database in accordance with one embodiment of the present invention.

FIG. 2 illustrates an image index stored in an image database in accordance with one embodiment of the present invention.

FIG. 3A illustrates a node entry in the image index structured to support locality-sensitive hashing in accordance with one embodiment of the present invention.

FIG. 3B illustrates a node entry added to the image index after storing a target image in the image database in accordance with one embodiment of the present invention.

FIG. 4 illustrates preprocessing of the target image in accordance with one embodiment of the present invention.

FIG. 5 illustrates similarity counting of the target image using locality-sensitive hashing in accordance with one embodiment of the present invention.

FIG. 6 is a flow chart detailing method operations for storing a processed target image to an image database based on comparison to an image index in accordance with one embodiment of the present invention.

### DETAILED DESCRIPTION

The following embodiments describe an apparatus and method for storing an image based on comparison to an image database. The present invention provides method which reduces the amount of required storage for images by encoding and storing the difference between different images in the image database. This results in a robust method that trades off processing resources for storage resources to address the increasing storage requirements for storing images online. It will be obvious, however, to one skilled in the art, that the present invention may be practiced without some or all of these specific details. In other instances, well known process operations have not been described in detail in order not to unnecessarily obscure the present invention.

While the storage costs for large collection of images is a large burden, the collection of images is processed to provide a robust method of compressing new images. Compression of images using an image database is enabled by being able to efficiently search the collection of images stored in an image database for an image that can be used as the model for image compression of additional images. By identifying similar reference images stored in the image database and using these reference images as the basis for image compression, a trade-off can be made between required processing and storage space to store images in an image database. The efficiency of searching the collection of images in the large image database can be increased by utilizing sub-linear algorithms, which are algorithms whose execution time grows slower than the size of the problem, but only provide an approximate solution.

Several methods may be used to determine which reference image stored in the image database is used as the basis for image compression. One method is to perform “brute force” searches which compare every image in the database to the image to be stored. Another method is octree, which searches the image database by recursively partitioning the image database into eight octants. In one embodiment of the present invention described below, locality-sensitive hashing (LSH) is used to identify the image used as the basis for image compression. LSH is a sub-linear algorithm which allows for efficient searches of approximate matches to identify a most similar image to be used as the basis for image compression. Further details on locality-sensitive hashing may be found in “Locality-Sensitive Hashing for Finding Nearest Neighbors” by Malcolm Slaney and Michael Casey, IEEE Signal Processing Magazine, pp 128-131, March 2008. This article is incorporated by reference for all purposes.

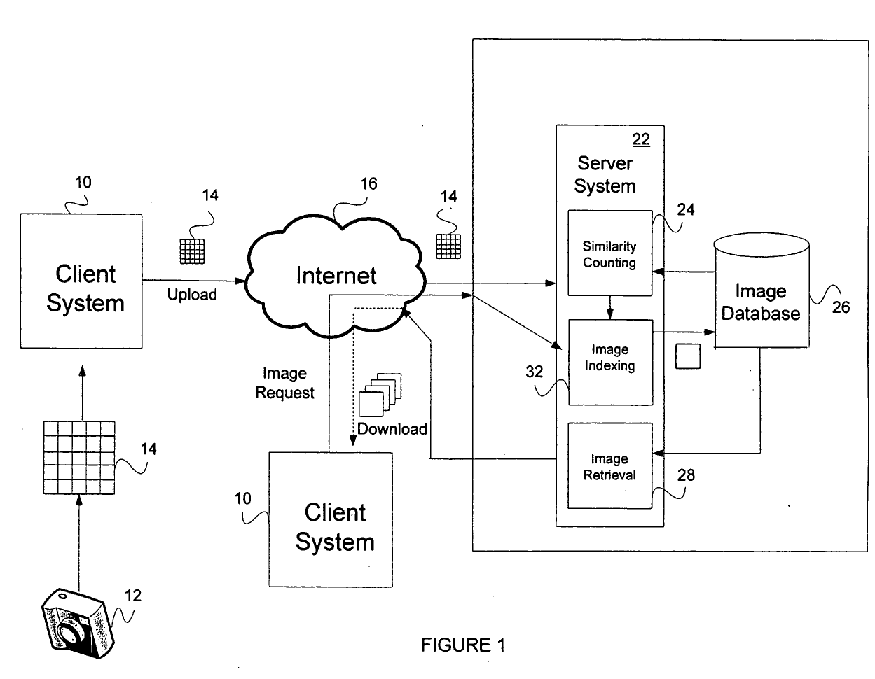

FIG. 1 illustrates a system enabling storage of a target image based on comparison to an image database in accordance with one embodiment of the present invention. A user uploads a target image 14 from a digital camera 12 to a client system 10. The client system 10 uploads a target image 14 to be stored on an image database 26 through an Internet connection 16. The image is a “target” image because the image is the object of an image search which compares the target image with reference images stored in an image database. The image database 26 stores a plurality of reference images and an image index. Each of the plurality of images stored in the image database 26 is indexed and the indices of the plurality of images are kept in the image index.

A server system 22, linked to the client system 10 through Internet 16, receives the uploaded target image 14. The server system 22 preprocesses the target image 14 to generate a processed target image. A difference between the target image 14 and an identified most similar reference image (MSI) is calculated by the server system 22, and the server system 22 reconstructs the target image 14 from the image database 26 upon receiving a download request from the client system 10. The cited method of uploading the target image 14 from the client system 10 to the server system 22 is for illustrative purposes, and as such does not limit the scope of the present invention. One with skill in the art will appreciate other methods of uploading the target image 14 to the server system 22 can be used, so long as the essential function of providing the target image 14 to the server system 22 is maintained.

The server system 22 includes a similarity counting module 24, which performs a search of the image index to find a most similar reference image stored to a processed target image. The server system 22 further includes an image indexing module 32, which subtracts a difference between the target image 14 and the most similar reference image and encodes the difference between the target image and the most similar reference image. In one embodiment, the difference between the target image and the most similar reference image is encoded using entropy encoding. Entropy encoding is a lossless data compression scheme which measures the amount of similarity between two images. In another embodiment, the image indexing module 32 resizes the most similar reference image to the size of the target image before the difference between the target image and the most similar reference image is calculated. In yet another embodiment, if the search of the image database by the similarity counting module 24 fails to identify a most similar reference image, the image indexing module 32 is bypassed and the entire target image 14 is stored.

The server system 22 reconstructs a stored image after the client system 10 requests a download of the stored image using an image retrieval module 28. The stored image is reconstructed by decoding the difference between the stored image and a corresponding most similar reference image and the image retrieval module 28 uses the decoded difference along with the most similar reference image to reconstruct the stored image.

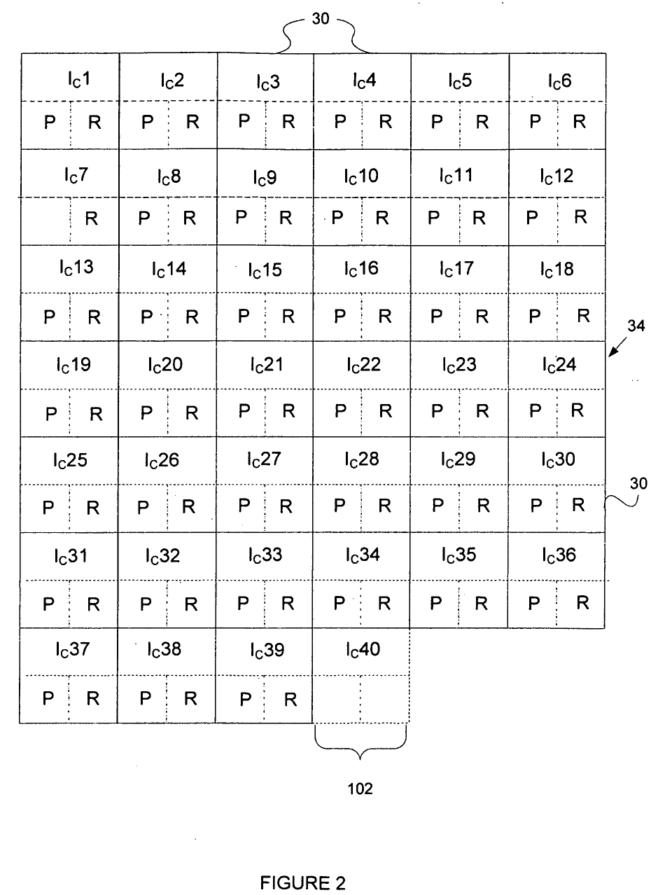

FIG. 2 illustrates an image index in accordance with one embodiment of the present invention. An image index 34 of the reference images stored in the image database 26 is generated. The image index 34 is implemented as a linked lists containing nodes 30 corresponding to each of a plurality of processed reference images stored in the image database 26. Each node 30 in the image index 34 includes data associating each reference image to a source image. Each processed reference image is constructed from a source image stored in the image database as well as the difference between the source image and the reference image. Newly stored images get a new entry 102 in the image index 34.

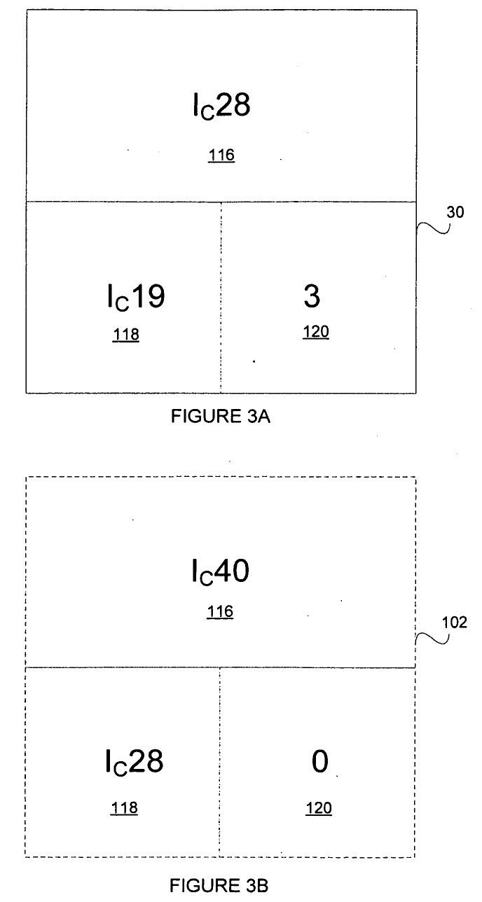

FIG. 3A illustrates a node entry in the image index structured to support locality-sensitive hashing in accordance with one embodiment of the present invention. In this embodiment, each node 30 of the image index has a data field 116 containing the encoded difference between the reference image and the source image stored in the image database, as well as a pointer pointing to a source image 118. In addition, each node 30 includes a count 120 of the number of processed images that refer to this image.

For example, the node 30 for image Ic28 illustrates the source image 118 is image Ic19 and the count 120 of the number of images that refer to image Ic28 is three. The node 30 has the data indicating the image Ic28 is locked and prevented from being deleted from the image database. In one embodiment, when the count 120 is greater than zero, the server system will treat the image as being locked. Locked reference images are prevented from being deleted from the image database, at least not without decompressing the compressed image and recompressing with a new target image.

FIG. 3B illustrates a node entry added to the image index after storing a target image in the image database in accordance with one embodiment of the present invention. A new node 102 is created in the image index when a target image is added to the image database. For example, image Ic40 102 is added to the image index using image Ic28 118 as the source image. The data field 116 contains the encoded difference between image Ic40 102 and the reference image Ic28 118, and the count 120 indicates none of the indexed reference images uses image Ic40 as the reference image. Since the count 120 is zero for this image Ic40, the image is not locked and can be deleted from the image database. It should be understood described data structure is cited for illustrative purposes, and as such do not limit the scope of the present invention.

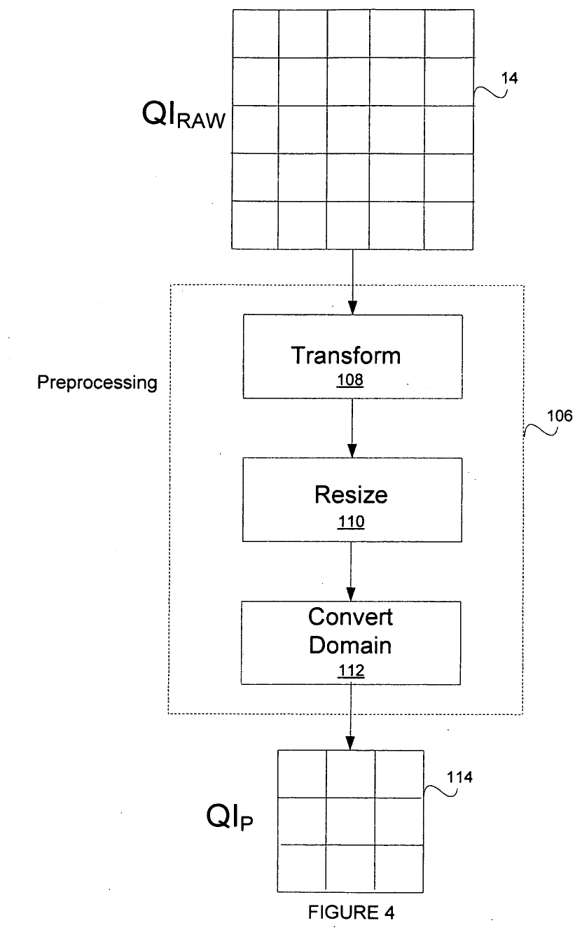

FIG. 4 illustrates preprocessing of the target image in accordance with one embodiment of the present invention. The target image 14 is preprocessed 106 to facilitate comparison with the plurality of processed reference images stored in the image index. The image is transformed into a new domain that is perceptually more relevant by performing image normalizations, which may include one or more of color space, image resolution and frequency domain normalization. The color space of the target image 14 is transformed 108 to a color space compatible with the color space of the processed reference images stored in the image index. Preprocessing 106 may further include resizing 110 the target image 14 to match the resolution of a plurality of processed reference images stored in the image index. The target image 14 is converted from a raw image 14 to the processed target image 112.

In one embodiment, the compression algorithm converting the target image to a processed target image is performed using a discrete cosine transformation (DCT). In another embodiment, the target image is converted into 64×64 DCT blocks and the target image is compared to the DCT coefficients of the plurality of processed images stored in the image index. The compression algorithm leverages the fact the most important coefficients in the DCT are the lowest-frequency terms and uses additional bits for the more important coefficients. In yet another embodiment, the color space of the target image 14 is transformed 108 into the YUV color space. In yet another embodiment, the domain of the target image 14 is converted 112 using a Fourier-Mellin transformation.

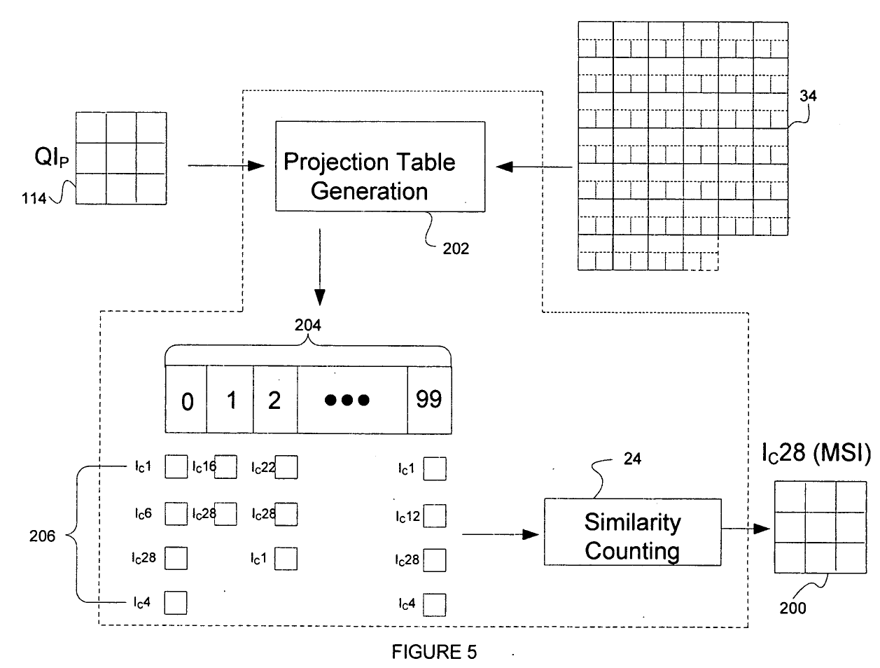

FIG. 5 illustrates similarity counting of the target image using locality-sensitive hashing in accordance with one embodiment of the present invention. Efficient storage of the target image is enabled by efficient identification of the most similar reference image 200 stored in the image database 26. Using LSH to search the image index, the server system generates a plurality of projection tables 202 using a plurality of processed reference images indexed in the image index 34 and the processed target image 114. The similarity counting module 24 queries the image index 34 to find approximate matches to the processed target image 114 and assigns 206 the processed reference images indexed in the image index which are similar to the processed target image 114 to each of the plurality of projection tables 204.

The similarity counting module 24 tabulates a number of occurrences of each of the processed reference images assigned 206 to each of the plurality of projection tables 204. The processed reference image with the highest number of occurrences is identified as the most similar processed reference image 200 of the processed target image 114.

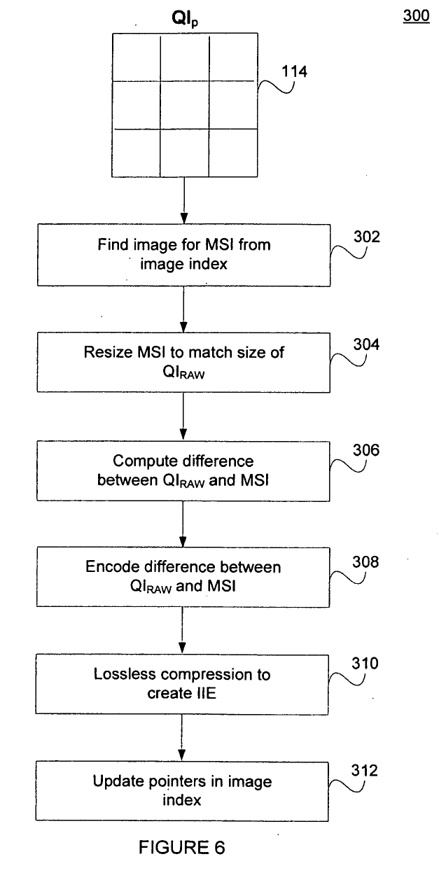

FIG. 6 is a flow chart detailing method operations for storing a processed target image to an image database based on comparison to an image index in accordance with one embodiment of the present invention. The method 300 starts in operation 302 by finding the most similar reference image to the processed target image 114. In one embodiment, the most similar reference image is identified by the processed reference image stored in the image index that has the highest number of occurrences of the processed reference images assigned to the plurality of projection tables using LSH, as illustrated in FIG. 5. In another embodiment, the comparison of the processed target image 114 to the processed reference images is done in the discrete cosine transform domain.

The method 300 advances to operation 304 by resizing the most similar reference image stored in the image database to match the resolution of the target image. In operation 306, the difference between the target image and the resized most similar reference image is computed. In one embodiment, the difference between the target image and the resized most similar reference image is computed in the frequency domain. Operation 308 encodes the difference between the target image and a resized image corresponding to the identified most similar reference image. In one embodiment, encoding the difference between the target image and the most similar reference image is performed using entropy encoding.

The method 300 advances to operation 310 where a new image index entry (IIE) is created. In another embodiment, the new image index entry is a node in a linked list, as shown in FIG. 2. Operation 312 updates a plurality of pointers corresponding to the plurality of processed reference images stored in the image database to account for the addition of the processed target image 114 to the image index. In one embodiment, the node for the new image index entry contains a field with data of the difference between the most similar reference image associated with the target image and the target image. Other data includes a field for the number of stored reference images which refers to the new image index entry, as illustrated in FIG. 3B. It should be understood described data structure is cited for illustrative purposes, and as such do not limit the scope of the present invention. Any suitable data structure may be used so long as the essential functions of similarity counting, image indexing, and image retrieval are maintained.

The invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of reducing storage capacity needed to store a target image in a database of images, comprising:
receiving a target image;
querying an image index to find an approximate match to the target image;
identifying a most similar reference image stored in an image index to a target image;
encoding the difference between the target image and the identified most similar reference image;
storing the difference between the target image and the identified most similar reference image in the image database; and
updating a pointer to the identified most similar reference image in the image index.

2. The method of claim 1, further comprising:
preprocessing the target image by the server system to facilitate comparison of the target image with the plurality of processed reference images stored in the image index.

3. The method of claim 2, preprocessing the target image further comprising:
transforming a color space of the target image;
subsampling the target image to match the resolution of a plurality of processed reference images stored in the image database; and
converting the target image to the frequency domain.

4. The method of claim 3, wherein transforming a color space of the target image is done in a YUV color space.

5. The method of claim 1, further comprising:
transforming the target image using a discrete cosine transformation.

6. The method of claim 1, further comprising:
decoding the stored difference between the target image and the identified most similar reference image in the image database; and
adding the stored difference between the target image and the identified most similar reference image to the identified most similar reference image, thereby reconstructing the target image.

7. The method of claim 1, further comprising:
utilizing a sub-linear algorithm to search the image index for the most similar reference image.

8. The method of claim 7, further comprising:
generating a plurality of projection tables using a plurality of processed reference images in the image database and the processed target image
assigning corresponding processed reference images similar to the processed target image to each of the plurality of projection tables; and
tabulating the number of occurrences of each of the processed reference images assigned to each of the plurality of projection tables, wherein the processed reference image with the highest number of occurrences is the most similar reference image associated with the processed target image.

9. The method of claim 1, wherein the pointer pointing to a stored processed reference image and a count of the number of processed reference images that refer to the corresponding processed image.

10. The method of claim 9, further comprising:
maintaining a lock on the corresponding processed reference image preventing the processed image from being deleted from the image database.

11. A computer readable media including program instructions for storage of an uploaded target image to an image database, comprising:
program instructions for uploading a target image from a client system to a server system;
program instructions for preprocessing the target image in the server system into a processed target image;
program instructions for determining a most similar processed reference image stored in an image index to a processed target image;
program instructions for resizing the most similar processed reference image to the size of the target image;
program instructions for subtracting the target image from the resized most similar processed reference image;
program instructions for encoding a difference between the target image and the resized most similar processed reference image; and
program instructions for updating the pointer in the image index, thereby storing the target image to the image database.

12. The computer readable media of claim 11, further comprising:
program instructions for transforming a color space of the target image;
program instructions for resizing the target image to match the resolution of a plurality of processed reference images stored in the image index; and
program instructions for converting the target image to the frequency domain.

13. The computer readable media of claim 12, wherein transforming a color space of the target image is done in the YUV color space.

14. The computer readable media of claim 12, wherein the target image is converted using a discrete cosine transformation and additional bits are used on low frequency coefficients.

15. The computer readable media of claim 11, further comprising:
program instruction for encoding the difference between the target image and the most similar reference image using entropy encoding.

16. A system enabling storage of a target image based on comparison to an image database, comprising:
a server system linked to the internet to receive uploaded the target image from a client system, the server system preprocesses the target image to generate a processed target image, the server system performs a search utilizing a sub-linear algorithm to find a most similar processed reference image to a processed target image, the system server calculates the difference between the target image and the identified most similar reference image, and the server system reconstructs the target image upon a download request from the client system; and
an image database for storing a plurality of reference images and an image index, the image index providing the plurality of processed reference images to the server system for similarity comparison.

17. The system of claim 16, wherein the server system includes a similarity counting module, the similarity counting module generates a plurality of projection tables using the plurality of processed reference images in the image index and the processed target image, the similarity counting module assigns processed images similar to the processed target image to each of the plurality of projection tables, and the similarity counting module tabulates a number of occurrences of each of the processed reference images assigned to each of the plurality of projection tables, wherein the processed reference image with the highest number of occurrences is a most similar reference image of the target image.

18. The system of claim 16, wherein the server system includes an image indexing module, the image indexing module subtracts a difference between the target image and the most similar reference image, and encodes the difference between the target image and the most similar reference image.

19. The system of claim 16, wherein the server system includes an image retrieval module, the image retrieval module reconstructs a stored image after the client system requests a download of the stored image, the stored image is reconstructed by decoding the difference between the stored image and a corresponding most similar reference image, and the image retrieval module uses the decoded difference and the most similar reference image to reconstruct the stored image to be downloaded.

20. The system of claim 16, wherein the image index is a linked list containing nodes corresponding to each of a plurality of processed reference images, each node includes a pointer pointing to a reference image and a count of the number of processed reference images referring to the corresponding processed reference image, wherein if the count of the number of processed reference images is greater than zero, the image is locked and prevented from being deleted from the image index.
